(19) United States
(12) Patent Application Publication
(10) Pub. No.: US 2025/0020331 A1
(43) Pub. Date: Jan. 16, 2025

(54) Electric Fireplace with Undermounted Flame Projector Module

(71) Applicant: Source Pro Industries Ltd, Kowloon Bay (HK)

(72) Inventors: Jackey Chu, Kowloon Bay (HK); Charles Lam, Kowloon Bay (HK)

(73) Assignee: Source Pro Industries Ltd, Kowloon Bay (HK)

(21) Appl. No.: 18/352,948

(22) Filed: Jul. 14, 2023

(51) Int. Cl. F24C 7/00; F21S 10/04

(52) U.S. Cl. CPC F24C 7/004; F21S 10/046

(57) ABSTRACT

The present disclosure relates to an electric fireplace with an under-mounted flame generator module, comprising a firebox in which an ornament module is provided and a base located under the firebox; wherein the base is provided with an accommodating chamber, and at least one flame generator module is installed in the accommodating chamber, the flame generator module comprises a flame generator.

### TECHNICAL FIELD

The present disclosure generally relates to an electric fireplace and more particularly relates to an electric fireplace with a flame projector module undermounted from the main enclosure.

### BACKGROUND

Most currently available electric fireplaces generally contains flame reflectors, a spindle motor, a light source and simulated logs or other ornaments, which are typically completely assembled and wired within the top surface of the enclosure's base panel which is the main viewing space for the fireplace ornaments and flame. Since the flame reflectors, spindle motor and light source would take significant space on this surface area, in current constructions these components are either:
a) embedded in the ornamental portion of the firebox typically including simulated fire grate, logs, embers etc, for example as shown in US20210404667A1; or
b) fully enclosed in the firebox and at the back of a translucent projection screen which hides the components from the user, for example as shown in US20060026894A1.

In construction a), the embedding of these components will negatively affect the aesthetics and realism of the ornaments which they are embedded within, as the size of the flame reflectors, spindle motor and light source must be accounted for in the shape of the ornaments which generally results in a over-sized uniform look which is unrealistic and aesthetically unappealing.

In construction b), the placement of these components at the back of a projection screen will significantly reduce the available viewing depth of the firebox which negatively affects the aesthetic and realistic aspect of the product. Also, the projection screen needs to be translucent material which has limitations to what materials can be used because the screen can't use real materials for cladding such as stone or brick on the back panel.

Also, in current constructions the number of flame generators may not exceed one without creating even more viewing constraints since the mounting space is limited, which makes the ornamental effect relatively monotonous.

The flame effect of these constructions viewing angle will also be limited to start at the height of where they are mounted on the top surface of the enclosure's base. Since space is needed for the reflectors to rotate without making contact to the base it is necessary for this position to be spaced upwards away from the base panel and therefore does not allow for the flame to start at the very bottom portion of the viewing angle near the base panel which is unrealistic as real flames would flicker at the very bottom area of the base and upwards.

Thirdly, in this kind of electric fireplaces, the grates or ornaments are wired to the light effects and cannot be interchanged with other ornaments without disconnecting and reconnecting connectors.

Therefore, in the prior art, there is a need for an electric fireplace, which allows to breakdown into modules with a reduced size for packaging, shipping and storing and then combine them in assembly at the manufacturer and to provide a more realistic flame effect with more realistic ornamental objects, such as a fire grate and logs which can also be mirrored on the flame screen, also allows to provide interchangeable grates and other ornaments without needing to be wired by connectors.

### SUMMARY

An objective of the present disclosure is to design an electric fireplace with under-mounted flame projector module, which allows for saving viewing space of the electric fireplace since the space is completely opened and using multiple flame generator modules for an even more beneficial effect and realistic visual effects. Also, the size of the electric fireplace could be reduced.

Another objective of the present disclosure is to allow the manufacturer to assemble the flame projector module and the ornaments into the base as the base is typically an assembled part, the user would then combine the other parts in assembly. Also, allows to use a simple ornament without any wiring, therefore can make a cleaner more realistic look for less cost with the option of easily interchanging ornaments without having to connect any wires.

The present disclosure relates to an electric fireplace with an under-mounted flame generator module, comprising a firebox in which an ornament module is provided; wherein a base is provided under the firebox and the base is provided with an accommodating chamber, at least one flame generator module is installed in the accommodating chamber, the flame generator module comprises a flame generator.

Wherein, the flame generator module further comprises a rotary electric reflector, the flame generator and the rotary electric reflector are assembled in a housing; the rotary electric reflector comprises a rotating shaft and some reflecting blades and the reflecting blades are arranged around the rotating shaft at intervals; a division plate is provided on the top of the base, the ornament module is provided on the division plate; the division plate is provided with a first light slot, the flame generator module is disposed below the first light slot, the light reflected by the rotary electric reflector is emitted through the first light slot.

In certain embodiments, at the position of a back panel of the firebox is provided with a projection screen, or a translucent plate is provided in front of the back panel of the firebox, or a reflective projection screen is provided at the position of the back panel of the firebox and a translucent plate is provided in front of the reflective projection screen with an interval;

Further, the projection screen is formed integrally with the back panel, or the projection screen is separately provided inside the firebox with the back panel at an interval; a second light slot is provided on the division plate, and a lighting device is provided at the position of the second light slot, the second light slot is disposed in front of the first light slot and located below the ornament module.

In certain embodiments, the ornament module comprises a grate and a first ornamental component placed on the grate.

Further, the ornament module further comprises a second ornamental component having an opening, the second ornamental component is placed at the rear of the first ornamental component; a lighting device is provided under the first ornamental component and a flame generator module is provided under the second ornamental component, or two flame generator modules are provided under the first ornamental component and the second ornamental component respectively, or only one flame generator module is provided under the first ornamental component and the second ornamental component; a translucent plate is provided in front of a back panel of the firebox and disposed on the top of the second ornamental component.

In certain embodiments, the flame generator module is a combined flame generator module, with a flame generator module and a lighting device enclosed in a housing.

Further, the housing of the combined flame generator module includes a cavity enclosed by a main body and a top cover, in the cavity is provided with a lighting device, a rotary electric reflector and a flame generator; an auxiliary housing is provided in the combined flame generator module, the rotary electric reflector and the flame generator are disposed inside the auxiliary housing, the lighting device is disposed outside the auxiliary housing.

In most embodiments, the base is a part installed independently of the firebox, or the base is a portion of a mantel structure in which the firebox is installed; the flame generator module could also be mounted using the inner structural beams of the base of the mantel structure.

Further, the ornament module comprises a translucent log with a hole positioned towards the back panel of the firebox in order to project a flame effect through the translucent log as an additional effect.

### BRIEF DESCRIPTION OF THE DRAWINGS

These and other features, aspects, and advantages of the present invention will become better understood with reference to the following description, appended claims, and accompanying drawings, in which similar reference characters refer to similar parts, and in which:

FIG. 1 shows a schematic diagram of an electric fireplace with under-mounted flame projector module according to the present disclosure;

FIG. 2 shows an exploded diagram of some parts of the electric fireplace with an under-mounted flame generator module according to the present disclosure;

FIG. 3 shows a cross-sectional view of a first embodiment of the electric fireplace according to the present disclosure, in which a lighting device and a single flame generator module are shown;

FIG. 4 shows a schematic diagram of an ornament module according to the present disclosure;

FIG. 5 shows a rear view of the flame generator module assembling with the division plate according to the present disclosure;

FIG. 6 shows an exploded diagram of some parts of the electric fireplace with an under-mounted flame generator module in a second embodiment;

FIG. 7 shows a cross-sectional view of a second embodiment of the electric fireplace according to the present disclosure, in which dual flame generator modules are shown;

FIG. 8 shows a rear view of the flame generator modules assembling with the division plate according to the second embodiment of the present disclosure;

FIG. 9 shows an exploded diagram of some parts of the electric fireplace with an under-mounted flame generator module in a third embodiment;

FIG. 10 shows a cross-sectional view of a third embodiment of the electric fireplace according to the present disclosure, in which only a single flame generator modules is shown;

FIG. 11 shows a rear view of the flame generator module assembling with the division plate according to the third embodiment of the present disclosure;

FIG. 12 shows a cross-sectional view of a fourth embodiment of the present disclosure;

FIG. 13 shows a cross-sectional view of a fifth embodiment of the present disclosure;

FIG. 14 shows a cross-sectional view of a sixth embodiment of the present disclosure;

FIG. 15 shows a cross-sectional view of a seventh embodiment of the present disclosure;

FIG. 16 shows a cross-sectional view of an eighth embodiment of the present disclosure;

FIG. 17 shows a cross-sectional view of a ninth embodiment of the present disclosure;

FIG. 18 shows a schematic diagram of the combined flame generator module of the present disclosure.

FIGS. 19-20 show an example in which a flame generator module is mounted onto a base frame from the top.

FIGS. 21-22 show another example in which a flame generator module is mounted onto a base frame from the side.

FIGS. 23-24 show a fully assembled and wired electric fireplace with under-mounted flame projector module according to the present disclosure.

### DETAILED DESCRIPTION

In order to make the objectives, technical solutions and advantages of the present disclosure clearer, the embodiments of the present disclosure will be described below in detail with reference to the accompanying drawings. The technical features in different embodiments of the present disclosure may be combined with each other if not conflicted.

Embodiments of the present invention are described herein in the context of an electric fireplace with under-mounted flame projector module. More particularly, it enables greater flexibility to the consumer for the overall design of the electric fireplace, as well as offering various cost and product development efficiencies. For example, numerous options for different components of the electric fireplace can be incorporated together in any desired manner to provide various alternatives for the consumer in terms of the overall size, shape, design and aesthetic appearance of the electric fireplace.

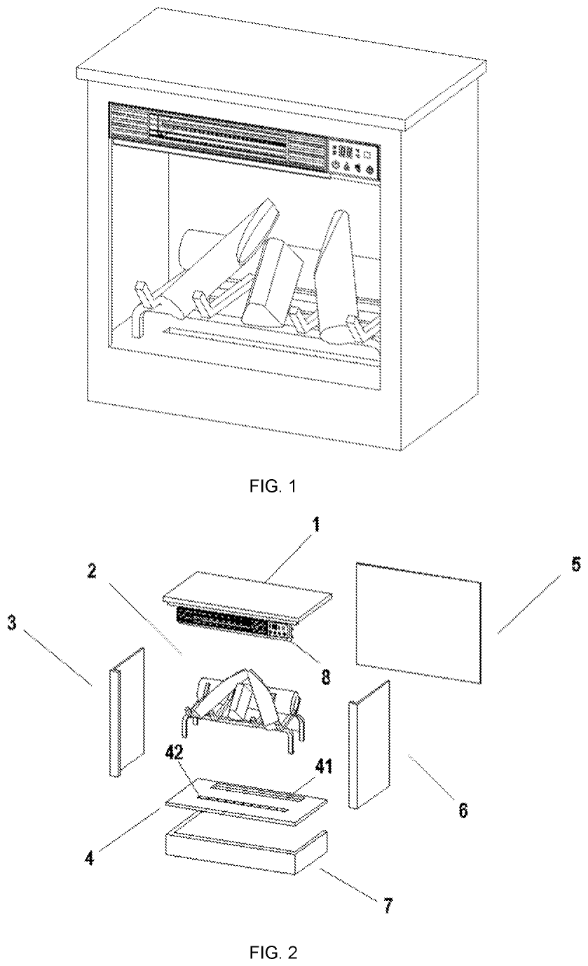

As shown in FIG. 1, a schematic diagram of an electric fireplace with an under-mounted flame generator module according to the present disclosure is shown. The electric fireplace is normally placed in an opening of a mantel structure, such as a wood mantle. FIG. 2 shows an exploded diagram of some parts of the electric fireplace with an under-mounted flame generator module according to the present disclosure. An electric fireplace with an under-mounted flame generator module according to the present disclosure comprises a top panel 1, a back panel 5, side panels 3 and 6 and a front cover which is not shown in the figure, enclosing an encapsulated firebox, wherein a base 7 is located below the firebox and can be manufactured and installed independently of the firebox, or the base 7 could be a portion of the mantel structure. Those skilled in the art are aware that in order to observe the ornamental effect inside the electric fireplace, the front cover needs to have a light transmission function.

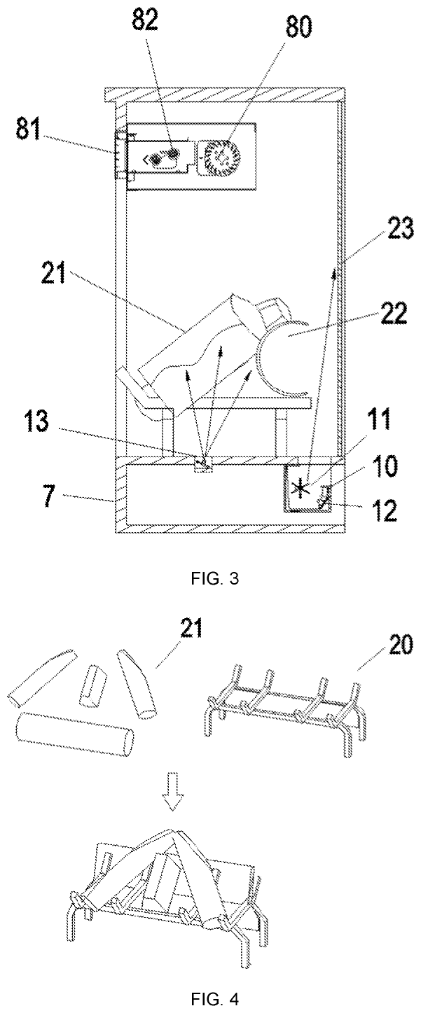

The electric fireplace also has a heater module 8, the heater module 8 may be located in the upper part of the firebox and below the top panel 1, with the function of heating air. Typically, as shown in FIG. 3, the heater module comprises a heating rod 82 and a blower 80, the heating rod 82 is disposed in the hot wind channel, the blower 80 is positioned nearby the hot wind channel. The wind blown by the blower 80 enters the hot wind channel, and after being heated by the heating rod, the hot wind is sent out from the outlet grille 81 located at the front end of the heater module.

As shown in FIGS. 2-3, the base 7 is provided with an accommodating chamber, and a single flame generator module is installed in the accommodating chamber, and the flame generator module is a component that can be installed independently. The flame generator module comprises a housing 10, which is provided with a flame generator 12 and a rotary electric reflector 11. The flame generator 12 is capable of emitting different colors of light, and can use different color combinations of bulbs or light strips. The rotary electric reflector 11 comprises a rotating shaft and some reflecting blades, and the reflecting blades are arranged around the rotating shaft at intervals. The rotating shaft can automatically rotate under the drive of the power supply, thus driving the reflecting blades to rotate. The rotary electric reflector 11 is disposed in front of the flame generator 12, so that the reflected light can be reflected backwards to the back panel of the fireplace. The top of the base 7 is provided with a division plate 4, and the flame generator module can be mounted onto the division plate 4, or an inner structural beam of the mantle base by fasteners such as screws. A first light slot 41 is provided on the division plate 4, and the flame generator module is disposed below the first light slot 41. The light reflected by the rotary electric reflector 11 can be emitted through the first light slot 41 and irradiated towards the back panel 5.

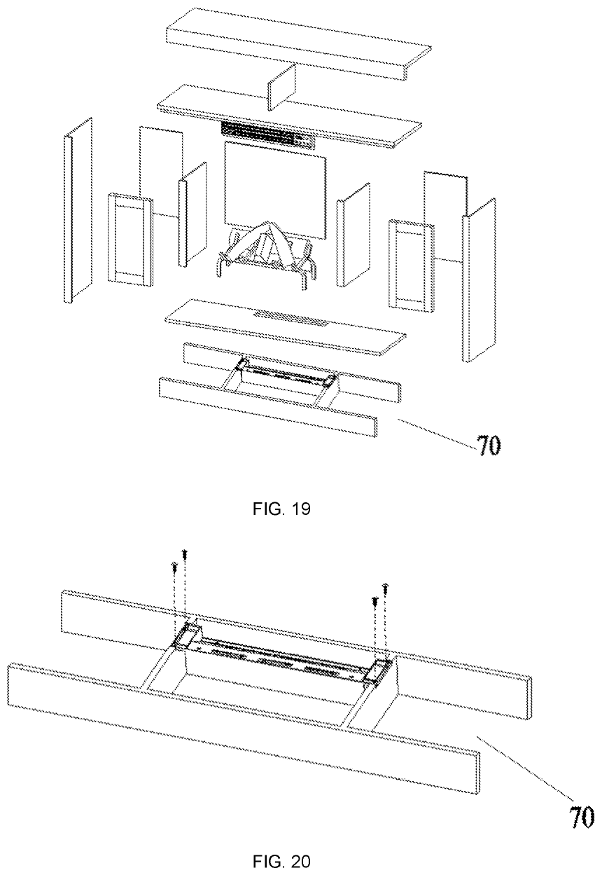

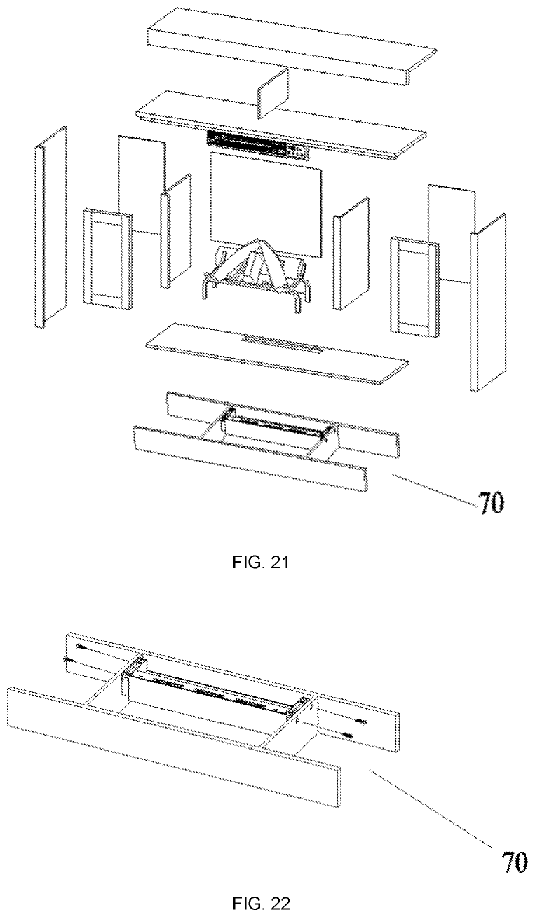

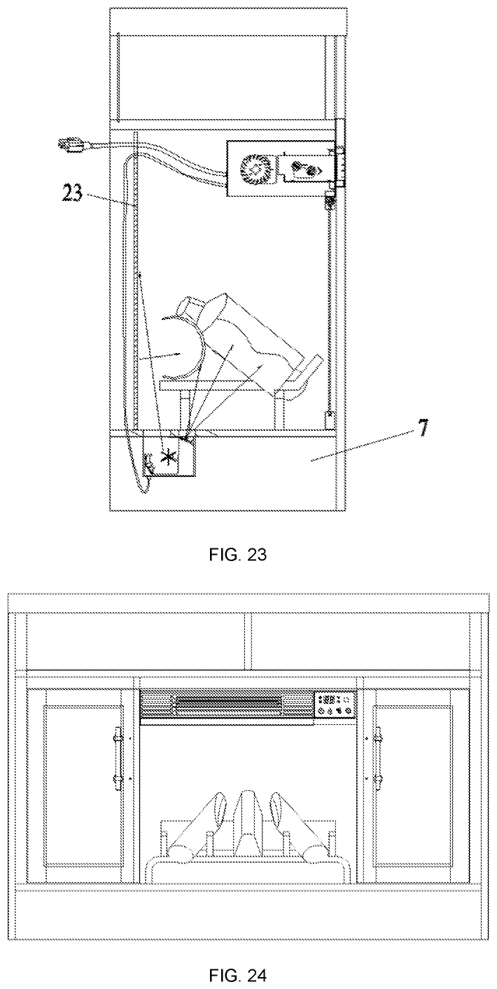

As shown in FIGS. 19-20, the base 7 comprises a base frame 70, onto which the flame generator module is mounted from the top with screws. As shown in FIGS. 21-22, the base 7 comprises a base frame 70, onto which the flame generator module is mounted from the side with screws. In both embodiments, the base frame 70 could be an inner structural beam of the mantle base as mentioned above. As shown in FIGS. 23-24, a fully assembled and wired electric fireplace with under-mounted flame projector module according to the present disclosure is illustrated, in which all of the modules are DC driven and powered by a main circuit board in the heater module 8.

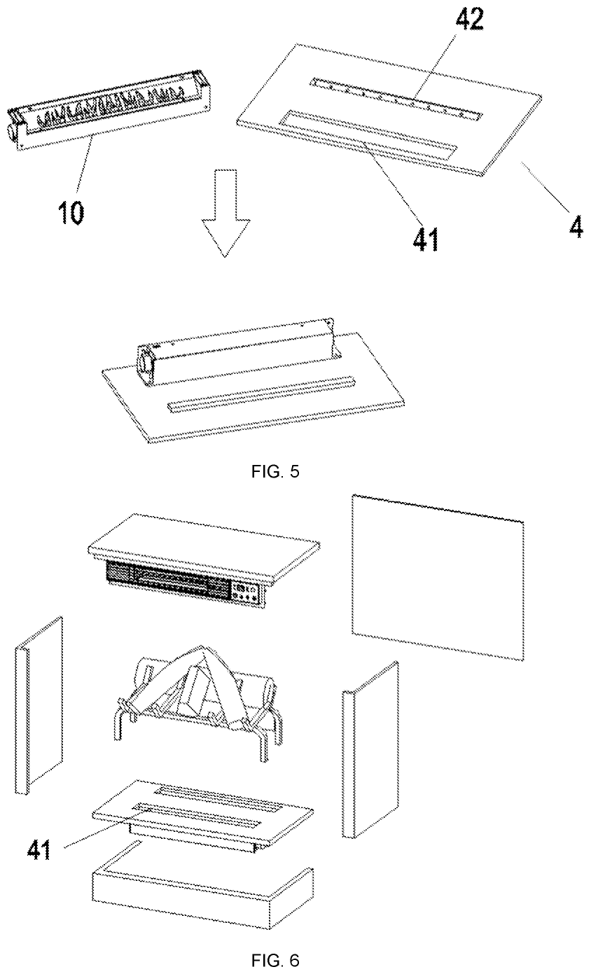

Above the division plate 4 is placed an ornament module 2 as an ornament, and the ornament module 2 is disposed in front of the first light slot 41. As shown in FIG. 4, the ornament module 2 comprises a first ornamental component 21 and a grate 20, at least one first ornamental component 21 is placed on the grate 20. The first ornamental component can be a log or crystal or other ornamental component, and the following description will be illustrated with log ornament as an example. Ornament module 2 further comprises a second ornamental component 22 having an opening especially a backward opening, and the second ornamental component 22 is placed at the rear of the first ornamental component 21 and can also be a log or crystal or other ornamental component. The second ornamental component 22 could be a translucent log with a hole positioned towards the back panel of the firebox in order to project a flame effect through the translucent log as an additional effect. The first ornamental component 21 and the second ornamental component 22 may be made of transparent or preferred translucent material, so that the ornamental effect and projection effect can be seen from the front cover. At the position of the back panel 5 is provided with a projection screen 23. The projection screen 23 may be formed integrally with the back panel 5, or it can be separately provided inside the firebox with an interval of the back panel 5. In addition to the first light slot 41, the division plate 4 may also provide with a second light slot 42, the second light slot 42 is disposed in front of the first light slot 41 and located below the ornament module 2. At the position of the second light slot 42 is provided with a lighting device 13, the lighting device 13 may be a strip light or an LED light. As shown in FIG. 5, a rear view of the flame generator module assembling with the division plate is shown, wherein the flame generator module is a separate module encapsulated in the housing 10. The flame generator module is mounted under the first light slot 41.

The light emitted by the flame generator 12 is reflected by the rotating reflecting blades, and irradiated to the projection screen 23 through the first light slot 41 on the division plate 4, forming a scrolling changing flame effect on the projection screen 23. From the front cover, the user can also observe the flame effect on the projection screen 23, even through the first ornamental component 21 and the second ornamental component 22. The light emitted by the lighting device 13 is directly irradiated on the first ornamental component 21 and the second ornamental component 22. From the front cover, the user can observe the overall ornamental effect inside the fireplace. By placing the ornaments on a separately power supplied lighting device, the ornament module in the present disclosure can be illuminated without any wires connected to the power supply, so that the installation and combination of the ornament module is convenient. There is no need to use wires to connect the ornament module with the power supply, and can present a variety of different combined visual effects.

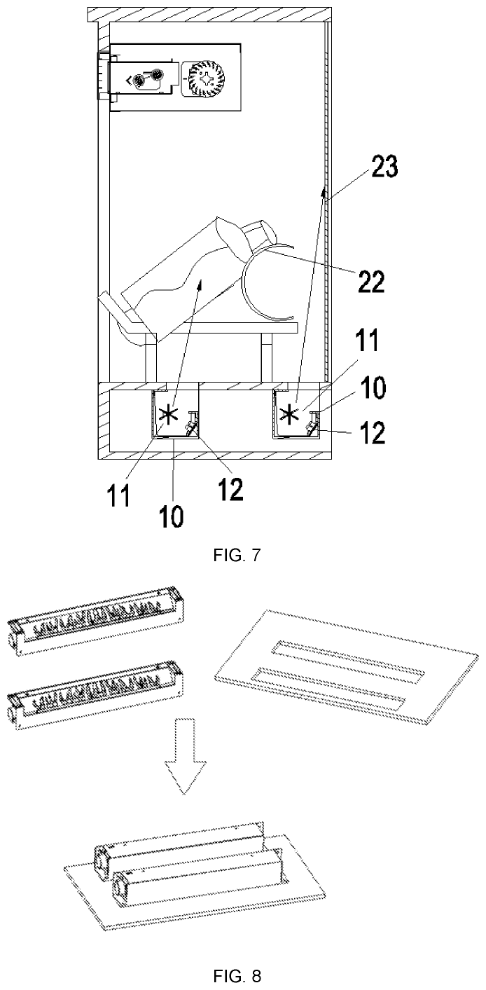

FIGS. 6-8 show a second embodiment with a dual flame generator module. In this embodiment, the lighting device 13 in the previous embodiment is replaced by another flame generator module, the dual flame generator modules are still installed in the accommodating chamber of the base 7. Correspondingly, the second light slot 42 on the division plate 4 is replaced by another first light slot 41. As shown in FIG. 7, the front flame generator module is located below the ornament module, and the rear flame generator module is located at the rear of the ornament module. The reflected light emitted by the rear flame generator module is projected onto the projection screen 23, and the light emitted by the front flame generator module is directly irradiated to the first ornamental component 21 and the second ornamental component 22. By changing the color of the light emitted by the flame generators, different flame effects can be observed.

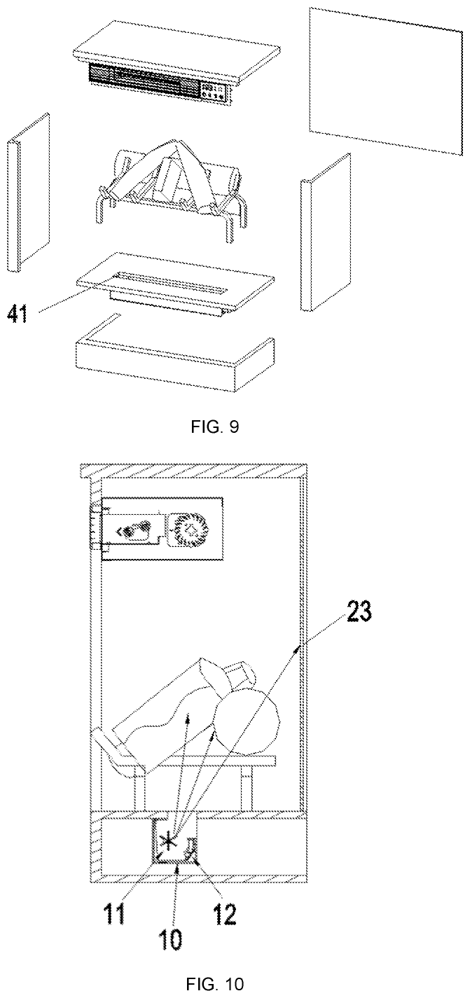

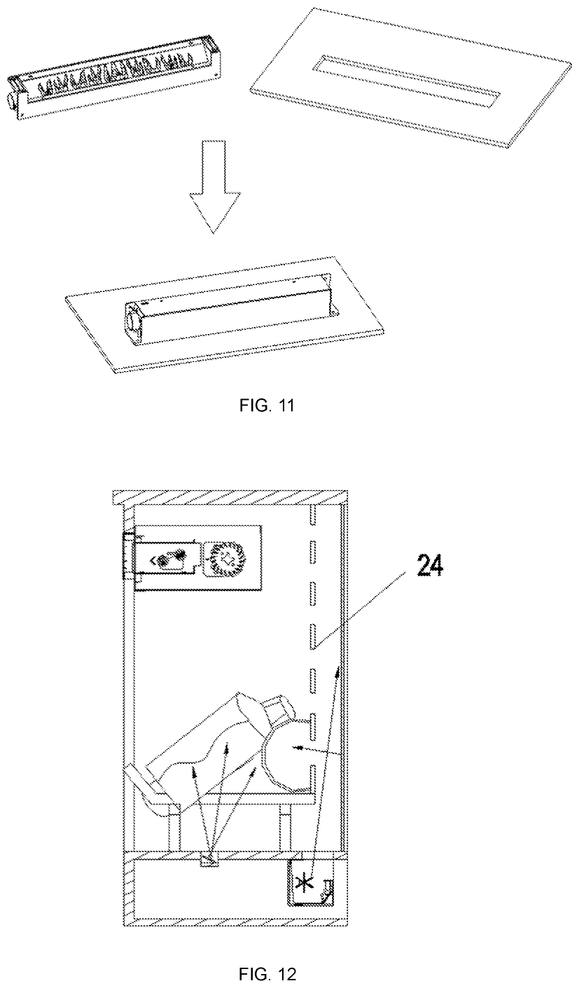

FIGS. 9-11 show a third embodiment having only a single flame generator module. In this embodiment, the flame generator module is still mounted in the accommodating chamber of the base 7, and is located below the ornament module 2, but the lighting device 13 is removed. Correspondingly, the division plate 4 also has only a first light slot 41. The light emitted by the flame generator module irradiates directly on the ornament module, and part of the light irradiates through the ornament module to the projection screen to form a projection effect. The ornament module and the projection screen create an overall visual effect of flame burning. This embodiment may make the thickness of the fireplace smaller, and is more suitable for miniaturized fireplace products.

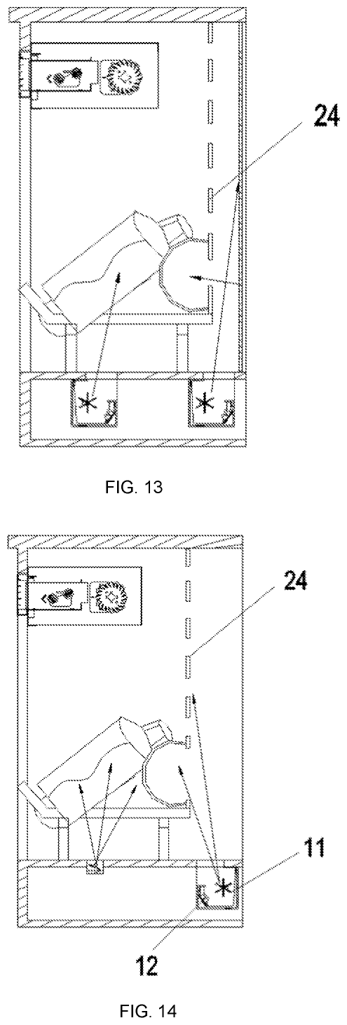

FIG. 12 shows a varied embodiment of the first embodiment, i.e., a fourth embodiment of the present disclosure. The embodiment differs from the first embodiment in that, in addition to a projection screen 23 positioned at the back panel, a translucent plate 24 is also provided in front of the projection screen 23. The translucent plate 24 and the projection screen 23 can be set parallel at an interval, and the projection screen 23 has a reflection function, that is, the projection screen 23 is a reflective projection screen, i.e. a mirrored projection screen. In this embodiment, the flame generator module is still installed in the accommodating chamber of the base 7, and the light emitted by the flame generator module is reflected on the translucent plate 24 after irradiating on the reflective projection screen 23. The light emitted by the lighting device 13 irradiates directly on the first ornamental component 21 and the second ornamental component 22. FIG. 13 shows a varied embodiment of the second embodiment, i.e., a fifth embodiment of the present disclosure. The dual flame generator modules are mounted in the accommodating chamber of the base 7, and a vertical translucent plate 24 is provided in front of the projection screen 23. The projection screen 23 has a reflective function, that is, the projection screen 23 is a reflective projection screen. These two embodiments can achieve different flame visual effects relative to the first and second embodiments.

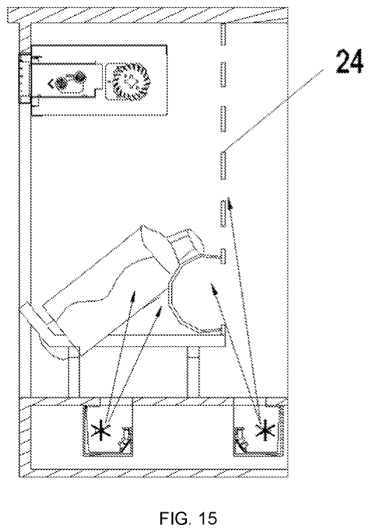

FIG. 14 shows a varied embodiment of the fourth embodiment, i.e., a sixth embodiment of the present disclosure. FIG. 15 shows a varied embodiment of the fifth embodiment, i.e., a seventh embodiment of the present disclosure. In the embodiments shown in FIGS. 14-15, there is no projection screen provided at the back panel, but only a translucent plate 24 is provided in front of the back panel. The translucent plate 24 needs to be disposed in front of the rear flame generator module. Correspondingly, the rotary electric reflector 11 in the flame generator module needs to be disposed at the rear of the flame generator 12, the light emitted by the flame generator 12 is reflected by the rotary electric reflector 11 and directly irradiates to the translucent plate 24 and the second ornamental component 22. The light emitted by the lighting device 13 or the front flame generator module irradiates directly on the first ornamental component 21 and the second ornamental component 22. Preferably, the translucent plate 24 may be disposed on the top of the second ornamental component 22 with an opening, i.e., the translucent plate 24 does not obscure the opening portion of the second ornamental component 22.

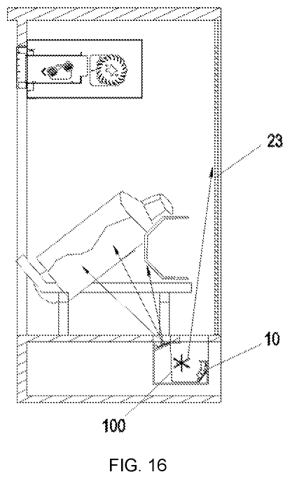

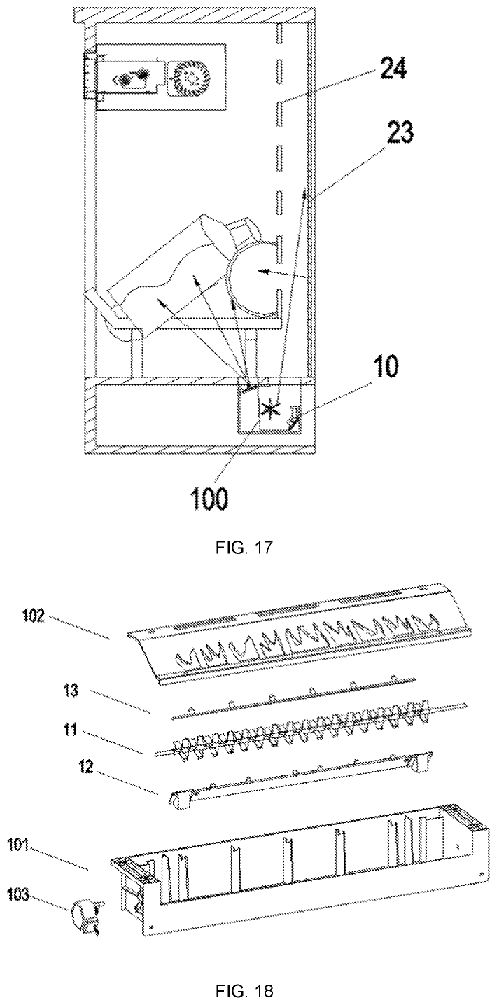

FIGS. 16-17 respectively shows the eighth and ninth embodiments of the present disclosure, which are the varied embodiments of the first embodiment shown in FIG. 3 and the fourth embodiment shown in FIG. 12 respectively, wherein a combined flame generator module is provided in the accommodating chamber of the base. Specifically, the combined flame generator module comprises a flame generator module and a lighting device as described above, i.e., the flame generator module and the lighting device are combined and encapsulated inside the housing 10. As shown in FIG. 16, the light emitted by the lighting device irradiates on the first and second ornamental components, and the light emitted by the flame generator module irradiates on the projection screen 23. In the embodiment shown in FIG. 17, the projection screen 23 has a reflective function, i.e., the projection screen 23 is a reflective projection screen. The front of the projection screen 23 is provided with a translucent plate 24, and the light reflected by the projection screen 23 irradiates on the translucent plate 24.

FIG. 18 shows a schematic diagram of the combined flame generator module of the present disclosure. The housing 10 comprises a main body 101 and a top cover 102, the main body 101 and the top cover 102 encloses a cavity. In the cavity of the housing 10 is provided with a lighting device 13, a rotary electric reflector 11 and a flame generator 12 in turn. The lighting device 13 is disposed in front of the rotary electric reflector 11 and the flame generator 12. Preferably, as shown in FIGS. 16-17, in order to prevent the light emitted by the lighting device 13 and the flame generator 12 from interfering with each other, an auxiliary housing 100 may be provided. The rotary electric reflector 11 and the flame generator 12 are disposed inside the auxiliary housing 100, and the lighting device 13 may be disposed outside the auxiliary housing 100. As shown in FIG. 18, the exterior of the housing 10 is further provided with a driving motor 103, the driving motor 103 is connected to the driving shaft of the rotary electric reflector 11.

By under-mounting the flame generator module in the base, it can save viewing space of the visual firebox since there is no space used on the main viewing area. It also allows for the option of using multiple flame generator modules for an even more beneficial effect as it can bounce the flame off objects on the firebox. It also looks more like a flame as the starting point from a visual vantage point, which looks like it is coming from under the grate or other objects such as logs. Also, the full firebox area and depth is now can be used for ornamental objects, thicker stone cladding textures, larger more realistic logs etc.

By under-mounting the flame generator module in the base, it also allows manufacturer to pre-assemble the flame projector module inside the base which is hollow and therefore does not add any additional packaging space for the flame generator module only. Additionally, it allows the manufacturer to take all the electronics out of the ornament module, allowing that to be a simple ornament without any wiring therefore can make a cleaner more realistic look for less cost. This is especially important for some of the smaller mantel models that have limited space and depth in the firebox area.

It is also possible to combine loose logs and other ornaments such as stones crystals, to allow the consumer to place logs in a preferred configuration, since the grate is not electrified and the illumination comes from a separated light strip module source. Other light strips can be installed in different areas of the mantel to create effects such as downlights, shadows, etc. Further, in various embodiments, the components of the electric fireplace can be configured relative to one another so that they can be packaged together much more compactly, which can provide even further cost efficiencies.

Although the implementations of the present disclosure are described above, the contents descried are only implementations used to understand the present disclosure and not intended to limit the present disclosure. Without departing from the spirit and scope disclosed by the present disclosure, any person skilled in the art to which the application belongs can make any modifications and alterations to the forms and details of implementation. However, the protection scope of the present disclosure shall still be subject to the scope defined by the appended claims.

1. An electric fireplace with an under-mounted flame generator module, comprising a firebox in which an ornament module is provided;
wherein a base is provided under the firebox and the base is provided with an accommodating chamber, at least one flame generator module is installed in the accommodating chamber, the flame generator module comprises a flame generator.

2. The electric fireplace according to claim 1, wherein the flame generator module further comprises a rotary electric reflector, the flame generator and the rotary electric reflector are assembled in a housing.

3. The electric fireplace according to claim 2, wherein the rotary electric reflector comprises a rotating shaft and some reflecting blades and the reflecting blades are arranged around the rotating shaft at intervals.

4. The electric fireplace according to claim 3, wherein a division plate is provided on the top of the base, the ornament module is provided on the division plate.

5. The electric fireplace according to claim 4, wherein the division plate is provided with a first light slot, the flame generator module is disposed below the first light slot, the light reflected by the rotary electric reflector is emitted through the first light slot.

6. The electric fireplace according to claim 1, wherein at the position of a back panel of the firebox is provided with a projection screen, or a translucent plate is provided in front of the back panel of the firebox, or a reflective projection screen is provided at the position of the back panel of the firebox and a translucent plate is provided in front of the reflective projection screen with an interval.

7. The electric fireplace according to claim 6, wherein the projection screen is formed integrally with the back panel, or the projection screen is separately provided inside the firebox with the back panel at an interval.

8. The electric fireplace according to claim 5, wherein a second light slot is provided on the division plate, and a lighting device is provided at the position of the second light slot, the second light slot is disposed in front of the first light slot and located below the ornament module.

9. The electric fireplace according to claim 1, wherein the ornament module comprises a grate and a first ornamental component placed on the grate.

10. The electric fireplace according to claim 9, wherein the ornament module further comprises a second ornamental component having an opening, the second ornamental component is placed at the rear of the first ornamental component.

11. The electric fireplace according to claim 9, wherein a lighting device is provided under the first ornamental component and a flame generator module is provided under the second ornamental component, or two flame generator modules are provided under the first ornamental component and the second ornamental component respectively, or only one flame generator module is provided under the first ornamental component and the second ornamental component.

12. The electric fireplace according to claim 10, wherein a translucent plate is provided in front of a back panel of the firebox and disposed on the top of the second ornamental component.

13. The electric fireplace according to claim 1, wherein the flame generator module is a combined flame generator module, with a flame generator module and a lighting device enclosed in a housing.

14. The electric fireplace according to claim 13, wherein the housing of the combined flame generator module includes a cavity enclosed by a main body and a top cover, in the cavity is provided with a lighting device, a rotary electric reflector and a flame generator.

15. The electric fireplace according to claim 14, wherein an auxiliary housing is provided in the combined flame generator module, the rotary electric reflector and the flame generator are disposed inside the auxiliary housing, the lighting device is disposed outside the auxiliary housing.

16. The electric fireplace according to claim 1, wherein the base is a part installed independently of the firebox, or the base is a portion of a mantel structure in which the firebox is installed.

17. The electric fireplace according to claim 16, wherein the flame generator module is mounted using an inner structural beam of the base of the mantel structure.

18. The electric fireplace according to claim 6, wherein the ornament module comprises a translucent log with a hole positioned towards the back panel of the firebox in order to project a flame effect through the translucent log as an additional effect.
